(19) United States
(12) Patent Application Publication
(10) Pub. No.: US 2016/0269748 A1
(43) Pub. Date: Sep. 15, 2016

(54) Intra-Picture Prediction Processor with Progressive Block Size Computations

(71) Applicant: NGCodec Inc., Sunnyvale, CA (US)

(72) Inventors: Alberto Duenas, Mountain View, CA (US); Kemal Ugur, Istanbul (TR)

(73) Assignee: NGCodec Inc., Sunnyvale, CA (US)

(21) Appl. No.: 15/066,277

(22) Filed: Mar. 10, 2016

Related U.S. Application Data
(60) Provisional application No. 62/132,472, filed on Mar. 12, 2015.

(51) Int. Cl. H04N 19/593; H04N 19/124; H04N 19/436; H04N 19/176; H04N 19/186; H04N 19/119; H04N 19/159

(52) U.S. Cl. CPC H04N 19/593; H04N 19/119; H04N 19/124; H04N 19/159; H04N 19/176; H04N 19/186; H04N 19/436

(57) ABSTRACT

An intra-picture prediction processor includes a first block size calculation kernel to produce a first intra-picture prediction angle for a first block size. The first block size calculation kernel utilizes a pre-defined set of intra-picture prediction modes to identify a first stage angle. The first block size calculation kernel utilizes the first stage angle to select a set of adjacent prediction angles to identify the first intra-picture prediction angle for the first block size. A second block size calculation kernel produces a second intra-picture prediction angle for a second block size larger than the first block size. The second block size calculation kernel utilizes the first intra-picture prediction angle to select a set of adjacent angles to identify the second intra-picture prediction angle for the second block size.

### CROSS REFERENCE TO RELATED APPLICATIONS

This application claims priority to U.S. Provisional Patent Application No. 62/132,472 filed on Mar. 12, 2015, the contents of which are incorporated herein by reference.

### FIELD OF THE INVENTION

This invention relates generally to video compression. More particularly, this invention relates to an intra-picture (or intra-frame) prediction processor.

### BACKGROUND OF THE INVENTION

High Efficiency Video Coding (HEVC) is a video compression standard that is the successor of the H.264/AVC video compression standard. The main differences between HEVC and H.264/AVC are the larger number of directional modes (33 prediction angles instead of 8) and the larger number of block sizes (from 4×4 to 32×32 instead of 4×4 to 16×16). These are the main reasons why HEVC encoders can deliver substantially higher compression efficiency compared with H.264/AVC. FIG. 1 illustrates the 33 prediction angles used in HEVC. The angles are defined so that the displacement between the angles is smaller close to horizontal and vertical directions and coarser towards the diagonal directions.

An intra-picture prediction search is used to predict current blocks in a picture from previously processed blocks of the same picture. Spatial redundancies are extracted to reduce the amount of data that needs to be transmitted to represent the picture. Intra-mode coding is performed by building a 3-entry list of modes. This list is generated using the left and above modes, along with some special derivations of them to come up with 3 unique modes. If the desired mode is in the list, the index is sent, otherwise the mode is sent explicitly.

Referring to FIG. 2, intra-picture prediction is the process of predicting block M from previously processed blocks A, B, C, D and E. As shown in FIG. 3, adjacent pixels and angular offsets from the previously processed blocks are used to construct the reference data that is used to predict M.

In the encoder previous block data needs to be available when performing the full prediction of block M, otherwise there will be a mismatch between the encoder and the decoder, as the decoder uses the reconstructed data from those blocks to reconstruct block M. The most important is the data in block A, which is the block that is processed just before M. Most of the directions are calculated from A and B. D is used for the one pixel between A and B. C and M are used for some of the directions.

One prior art approach to intra-picture prediction is performed at the encoder using the incoming video pictures. In this case, the encoder and the decoder will not perform exactly the same process. The decoder will use the actually reconstructed data from the neighboring blocks, while the encoder uses the incoming video. This leads to a mismatch between the encoding and decoding processes, leading to artifacts and long term issues that need to be addressed using other techniques. The advantage of operating on the incoming video is that the processing of the individual blocks can be performed in parallel and the prediction process for Block A could continue even when the prediction process of block M has started, as M does not need the data from A to perform its prediction.

Another prior art approach has all the blocks (A, B, C, D, E) previously predicted and reconstructed by the time the prediction of M has started. In this case the actual reconstructed data is used for the prediction of block M (as is the case with the decoder). In this case those blocks need to be fully reconstructed before performing the intra-picture prediction of block M. The intra-picture prediction needs to be performed at the same time as some of the other elements of the encoder as the Q, T, T⁻¹ and Q⁻¹ (including the mode decision). It is challenging to calculate the high number of directions and block sizes available with HEVC in the available number of cycles. The need for fully reconstructed data in blocks surrounding block M leads to difficult constraints in the use of block-level parallelism.

In view of the foregoing, it would be desirable to provide improved block processing techniques in connection with intra-picture prediction processing.

### SUMMARY OF THE INVENTION

An intra-picture prediction processor includes a first block size calculation kernel to produce a first intra-picture prediction angle for a first block size. The first block size calculation kernel utilizes a pre-defined set of intra-picture prediction modes to identify a first stage angle. The first block size calculation kernel utilizes the first stage angle to select a set of adjacent prediction angles to identify the first intra-picture prediction angle for the first block size. A second block size calculation kernel produces a second intra-picture prediction angle for a second block size larger than the first block size. The second block size calculation kernel utilizes the first intra-picture prediction angle to select a set of adjacent angles to identify the second intra-picture prediction angle for the second block size.

### BRIEF DESCRIPTION OF THE FIGURES

The invention is more fully appreciated in connection with the following detailed description taken in conjunction with the accompanying drawings, in which:

FIG. 1 illustrates prediction angles supported by HEVC.

FIG. 2 illustrates intra-picture prediction of block M based, upon previous blocks A, C, B, D and E.

FIG. 3 illustrates adjacent block pixels and offset angles used to construct block M.

FIG. 4 illustrates progressive block size processing performed in accordance with an embodiment of the invention.

FIG. 5 illustrates two-stage intra-picture prediction processing performed in accordance with an embodiment of the invention.

FIG. 6 illustrates a semiconductor configured to implement disclosed operations.

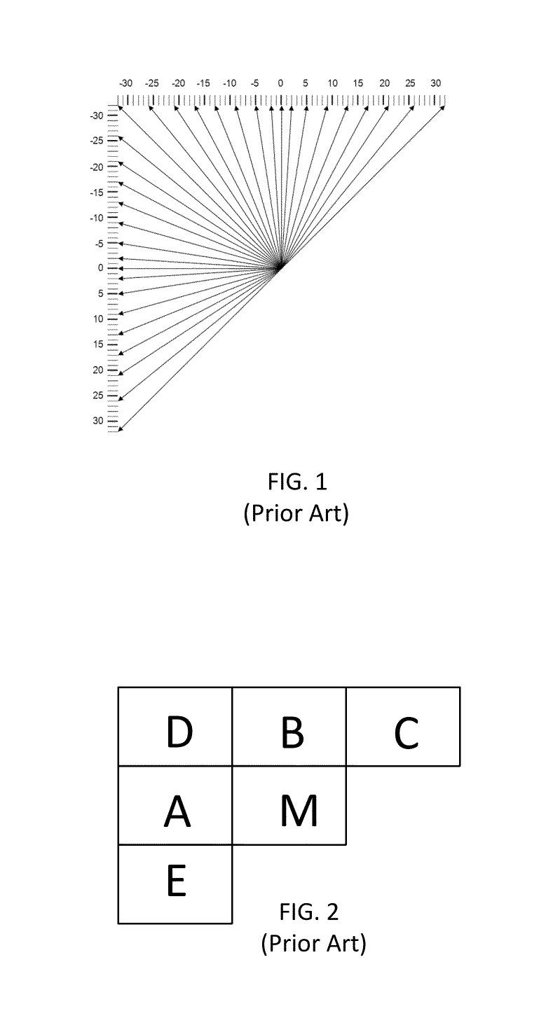

Like reference numerals refer to corresponding parts throughout the several views of the drawings.

### DETAILED DESCRIPTION OF THE INVENTION

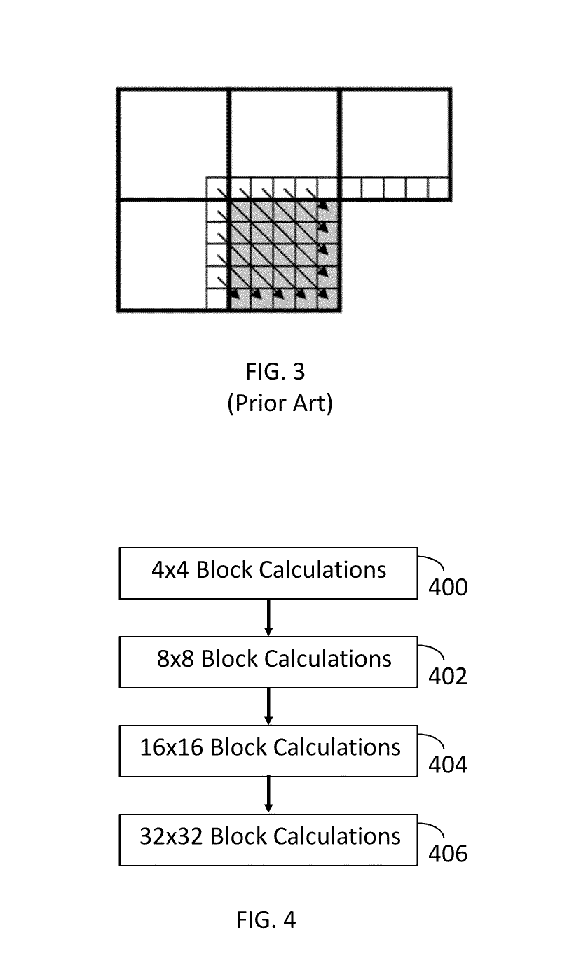

One embodiment of the invention is an efficient intra-picture prediction search mechanism with reduced complexity that supports multiple block sizes. FIG. 4 illustrates a sequence of processing wherein increasingly larger block size calculations are performed. Each subsequent set of calculations is informed by information gathered in prior calculations. In one embodiment, 4×4 block calculations 400 are performed, followed by 8×8 block calculations 402, followed by 16×16 block calculations 406 and then 32×32 block calculations 406.

More particularly, 4×4 block calculations 400 compute the intra-picture prediction angle for the specified block size. Based on these results, intra-picture prediction angles are progressively computed for larger blocks. The 4×4 block calculation 400 may be characterized as including a step 1(a) in which a pre-defined set of intra-picture prediction modes for 4×4 blocks are searched. In a step 1(b) a set of intra-picture prediction modes for 4×4 blocks are searched, where the set depends on the results of Step 1(a). In one embodiment, for step 1(a), the pre-defined set is defined as DC, Horizontal, Vertical and selected diagonal modes (e.g., modes 18 & 34). For step 1(b), the 8 angles closest (+−4) to the best angle found in step 1(a) are searched.

The 8×8 block calculations 402 may be considered step 2. A set of intra-picture prediction modes for 8×8 blocks is searched, where the set depends on the results from step 1. The DC, Horizontal, Vertical and selected diagonal angles (e.g., modes 18 & 34) are searched. The best angle and the two closest angles from the smaller block size corresponding to the top-left corner of the block are used.

The 16×16 block calculations 404 may be considered step 3. A set of intra-picture prediction modes for 16×16 blocks is searched, where the set depends on the results from step 1 and step 2. The DC, Horizontal, Vertical and selected diagonal angles (e.g., modes 18 & 34) are searched. The best angle and the two closest angles from the smaller block size corresponding to the top-left corner of the block are used.

The 32×32 block calculations 406 may be considered step 4. A set of intra-picture prediction modes for 32×32 blocks is searched, where the set depends on the results from step 1, step 2 and step 3. The DC, Horizontal, Vertical and selected diagonal angles (e.g., modes 18 & 34) are searched. The best angle and the two closest angles from the smaller block size corresponding to the top-left corner of the block are used.

In one embodiment, the cost function used to select the best angle is a distortion measure between the prediction and the original pixels. There could be an additional cost parameter if the selected angle is not included in the most probable modes for the given block. The construction of the search set could depend on the bit rate. More particularly, a smaller number of angles could be searched for higher bit rates.

Based on some measure, the construction of the search set could be dynamically updated. For example, if there is a need to dynamically go to a lower complexity operation level, large block sizes could use the same angles found from the smaller block sizes. For steps 2, 3 and 4 the search set can be constructed using the angles from all four smaller blocks, instead of just using the corresponding top-left corner position. For example, the angle that occurs the most often among the four child blocks could be included in the set. Alternately, two of the angles among the four child blocks and their corresponding neighbors could be included in the set.

All of the processing steps need not be performed. Computation constraints or bit rate requirements may dictate that only a couple of progressive block size calculations be performed. Low frequency data (largely uniform pixels) in large segments of a frame will facilitate larger block size calculations, while high frequency data (largely variable pixels) may reduce the practicality of proceeding to larger block size calculations. An embodiment of the invention adaptively determines the number of block size calculations to perform based upon system parameters and data parameters.

Another embodiment of the invention is an intra-prediction process that first computes parts of the intra-prediction prediction process using the incoming video to calculate some of the directions. These operations are performed in parallel.

Another embodiment of the invention refines the calculated angles based on the most probable modes for the corresponding blocks. More specifically, best angles for each candidate block size are first calculated as described above. The best partitioning of the block sizes is then determined based on the results of the angle search. Using the partition information, the most probable mode (called an “mpm list” in the H.265/HEVC standard) is constructed for each block. Using this constructed list, the cost for each angle is refined (if the angle belongs to the mpm list for that block, its cost is decreased accordingly). Using updated cost functions, new angles are selected. For this embodiment, the angle information for the chroma and luma components can be treated differently. For example, this refinement can be performed only for the luma component.

Based on the results of this first stage, a second stage uses the actual reconstructed data to perform a second intra-picture prediction process. Since the second stage relies upon actual reconstructed data, it is operates in the same manner as the decoder. Thus, the invention leverages parallel processing in the first stage, while encoding in the second stage in a manner that is consistent with the operations at the decoder, thereby insuring alignment between the processing at the encoder and decoder.

FIG. 5 illustrates a first stage 500 receiving incoming video, which is used to produce intermediate intra-picture prediction data, which is supplied to the second stage 502. Individual blocks of incoming video are fed on line 504 to the second stage 502. Previously processed blocks E, D, B, C and A have a feedback path 506 into the second stage 502. When block M is on line 504, block A (the last processed block) is on line 506.

This technique achieves superior results and avoids drifting between the encoder and the decoder. The technique leads to a smaller design with good performance and flexibility without any mismatch with the decoder.

The first stage 500 uses the incoming video to make decisions using a larger number of cycles to perform operations. In particular, the DC, planar and angular modes for a 4×4 block and then larger block sizes are predicted. At this stage most of the possible directions, the best intra-picture prediction mode and the best intra-picture block size are predicted.

The second stage 502 uses the actual reconstructed data to be able to achieve the best results and avoid drifting between encoder and decoder. The second stage 502 recalculates the best mode that was produced by the first stage 500. Small refinements of previously calculated modes are performed. The full prediction, transform and quantization will lead to the actual cost that will be used to perform a rate distortion optimization (RDO), which will determine the best prediction unit size to encode a portion of the image.

Based on the best prediction unit size (or multiple prediction unit sizes in the higher complexity cases) identified in the first stage 500 and the best directions selected at the first stage 500, the second stage 502 uses that information on the actual reconstructed video. The best direction is calculated to select the best intra-picture predicted prediction unit size and the best angular direction. The prediction unit needs to be fully processed at the second stage 502 leading to performing inter/intra mode decisions, as well as the Q, T, T−1 and Q−1 (including the mode decision) at the second stage 502.

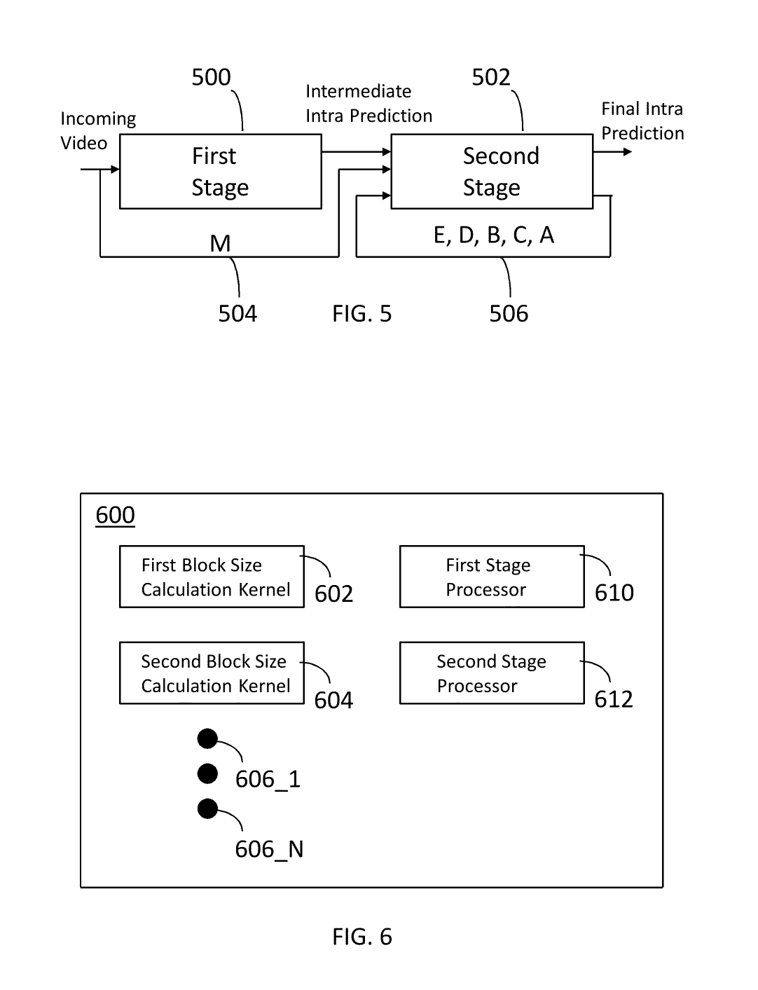

The operations characterized in connection with FIGS. 4 and 5 are implemented in hardware. In particular, an application specific integrated circuit (ASIC), field-programmable gate array (FPGA) or similar hardware architecture is utilized to implement the disclosed operations. FIG. 6 illustrates a semiconductor substrate 600 with a first block size calculation kernel 602, which includes circuitry to implement the 4×4 block calculations 400. The semiconductor 600 also includes a second block size calculation kernel with circuitry to implement 8×8 block calculations 402. Additional resources 606_1 through 606_N may be used to implement larger block size calculations. The semiconductor 600 also includes a first stage processor 610 to implement the operations of first stage 500 and a second stage processor 612 to implement the operations of second stage 502.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. An intra-picture prediction processor, comprising:
a first block size calculation kernel to produce a first intra-picture prediction angle for a first block size, wherein the first block size calculation kernel utilizes a pre-defined set of intra-picture prediction modes to identify a first stage angle, and wherein the first block size calculation kernel utilizes the first stage angle to select a set of adjacent prediction angles to identify the first intra-picture prediction angle for the first block size; and
a second block size calculation kernel to produce a second intra-picture prediction angle for a second block size larger than the first block size, wherein the second block size calculation kernel utilizes the first intra-picture prediction angle to select a set of adjacent angles to identify the second intra-picture prediction angle for the second block size.

2. The intra-picture prediction processor of claim 1 wherein the pre-defined set of intra-picture prediction modes includes DC, Horizontal, Vertical and selected diagonal prediction angles.

3. The intra-picture prediction processor of claim 1 wherein the set of adjacent prediction angles includes eight prediction angles closest to the first stage prediction angle.

4. The intra-picture prediction processor of claim 1 wherein the first intra-picture prediction angle and the second intra-picture prediction angle are selected based upon a cost function.

5. The intra-picture prediction processor of claim 4 wherein the cost function is a distortion measure between a prediction and original pixels.

6. The intra-picture prediction processor of claim 1 further configured to adaptively determine whether to perform additional block size calculations.

7. The intra-picture prediction processor of claim 6 further configured to adaptively determine whether to perform additional block size calculations based upon a quantization parameter.

8. The intra-picture prediction processor of claim 6 further configured to adaptively determine whether to perform additional block size calculations based upon a system performance parameter.

9. The intra-picture prediction processor of claim 6 further configured to adaptively determine whether to perform additional block size calculations based upon a data frequency parameter.

10. The intra-picture prediction processor of claim 1 further comprising:
a third block size calculation kernel to produce a third intra-picture prediction angle for a third block size larger than the second block size, wherein the third block size calculation kernel utilizes at least one of the first intra-picture prediction angle and the second intra-picture prediction angle to select a set of adjacent angles to identify the third intra-picture prediction angle for the third block size.

11. The intra-picture prediction processor of claim 10 further comprising:
a fourth block size calculation kernel to produce a fourth intra-picture prediction angle for a fourth block size larger than the third block size, wherein the fourth block size calculation kernel utilizes at least one of the first intra-picture prediction angle, the second intra-picture prediction angle and the third intra-picture prediction angle to select a set of adjacent prediction angles to identify the fourth intra-picture prediction angle for the fourth block size.

12. The intra-picture prediction processor of claim 11 wherein the first block size is 4×4.

13. The intra-picture prediction processor of claim 11 wherein the second block size is 8×8.

14. The intra-picture prediction processor of claim 11 wherein the third block size is 16×16.

15. The intra-picture prediction processor of claim 11 wherein the fourth block size is 32×32.

16. An intra-picture prediction processor, comprising:
a first calculation kernel to produce candidate angles for different block sizes;
a second calculation kernel to produce a most probable mode list with most probable angles based upon the candidate angles for the different block sizes; and
a third calculation kernel to select the best angle based upon the candidate angles and the most probable angles.

17. The intra-picture prediction processor of claim 16 wherein the third calculation kernel calculates the best angle by processing the most probable mode list for the different block sizes and reduces the cost for each candidate angle within each most probable mode list.

18. The intra-picture prediction processor of claim 16 wherein the third calculation kernel selectively assigns a best angle to a luma angle and a chroma angle.

19. The intra-picture prediction processor of claim 16 wherein the third calculation kernel selectively calculates separate best angles for a luna angle and a chroma angle.
